(19) United States
(12) Patent Application Publication
(10) Pub. No.: US 2025/0356167 A1
(43) Pub. Date: Nov. 20, 2025

(54) NEURAL NETWORK MODEL TRAINING METHOD AND APPARATUS, PROGRAM PRODUCT AND STOARGE MEDIUM

(71) Applicant: Tencent Technology (Shenzhen) Company Limited, Shenzhen (CN)

(72) Inventor: Jun WANG, Shenzhen (CN)

(73) Assignee: Tencent Technology (Shenzhen) Company Limited, Shenzhen (CN)

(21) Appl. No.: 19/285,096

(22) Filed: Jul. 30, 2025

Related U.S. Application Data
(63) Continuation of application No. PCT/CN2024/104865, filed on Jul. 11, 2024.

(30) Foreign Application Priority Data
Jul. 14, 2023 (CN) 202310870455.8

(51) Int. Cl. G06N 3/045; G06N 3/09

(52) U.S. Cl. CPC G06N 3/045; G06N 3/09

(57) ABSTRACT

Embodiments of the present disclosure disclose a neural network model training method and apparatus, a computer program product, and a storage medium. The method includes: initializing an information processing neural network model and a reference neural network model corresponding to the information processing neural network model, the information processing neural network model including a plurality of processing modules, and the reference neural network model including a plurality of reference modules; and updating a parameter of the information processing neural network model and a parameter of the reference neural network model through a plurality of iterations.

### CROSS-REFERENCE TO RELATED APPLICATIONS

This application is a continuation of International Patent Application No. PCT/CN2024/104865, filed Jul. 11, 2024, which claims the benefit of priority to Chinese Patent Application No. 2023108704558, filed Jul. 14, 2023. The contents of International Patent Application No. PCT/CN2024/104865 and Chinese Patent Application No. 2023108704558 are herein incorporated by reference in their entirety.

### FIELD OF THE TECHNOLOGY

The present disclosure relates to the field of artificial intelligence, and more particularly, to a neural network model training method and apparatus, a computer program product, and a storage medium, and a method and apparatus for performing an information processing task based on a neural network model, a computer program product, and a storage medium.

### BACKGROUND OF THE DISCLOSURE

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, artificial intelligence is a branch of computer science and attempts to understand the essence of intelligence and produce a new intelligent machine that can react in a manner similar to human intelligence. Artificial intelligence is mainly to study the design principles and implementation methods of various intelligent machines, to enable the machines to have functions of perception, reasoning, and decision-making. Research in the field of artificial intelligence relates to robot control, natural language processing, computer vision, decision-making and reasoning, human-computer interaction, information recommendation and search, and the like.

As an important branch of artificial intelligence, a neural network (NN) is a network structure that imitates behavior features of animal neural networks to perform information processing. The structure of the neural network is composed of a large number of nodes (or referred to as neurons) that are connected to each other. The neural network learns and trains input information based on a particular operation model, to process information. A neural network includes an input layer, a hidden layer, and an output layer. The input layer is responsible for receiving an input signal. The output layer is responsible for outputting a calculation result of the neural network. The hidden layer is responsible for a calculation process such as learning or training, and is a memory unit of a network. A memory function of the hidden layer is represented by a weight matrix. Usually, each neuron corresponds to a weight coefficient.

As the number of network layers of a neural network model increases, a scale of network parameters increases. As the scale of network parameters increases, a difficulty of model training increases, and time required for training is also prolonged. In particular, it is hard to train a self-supervised learning (SSL) model due to a pattern or dimension crash. Therefore, how to effectively improve efficiency of training a neural network model and reduce time consumption of model training is a problem that needs to be solved urgently.

### SUMMARY

An existing neural network model training method usually uses a method in which outputs of all processing modules of a neural network model are sequentially calculated through forward propagation, then gradients of a loss function with respect to parameters of the processing modules are sequentially calculated through backward propagation, and parameters of an entire neural network are updated according to the gradients. In this method, both the forward propagation process and the backward propagation process involve all the processing modules of the neural network. In addition, in the backward propagation process, a network parameter of each processing module needs to be updated only in a case that network parameters of all processing modules behind the processing module are clarified. Therefore, efficiency of training the entire model is low.

To improve efficiency of training a neural network model, the present disclosure provides a neural network model training method, including: initializing an information processing neural network model and a reference neural network model corresponding to the information processing neural network model, the information processing neural network model including a plurality of processing modules, and the reference neural network model including a plurality of reference modules; and updating a parameter of the information processing neural network model and a parameter of the reference neural network model through a plurality of iterations: in each iteration, determining output results respectively corresponding to the plurality of reference modules based on a training sample and parameters of the plurality of reference modules; determining output results respectively corresponding to the plurality of processing modules based on a masked sample obtained after performing mask processing on the training sample and parameters of the plurality of processing modules; updating the parameters of the plurality of processing modules based on the output results respectively corresponding to the plurality of processing modules and the output results respectively corresponding to the plurality of reference modules; and updating the parameters of the plurality of reference modules based on updated parameters of the plurality of processing modules.

An embodiment of the present disclosure further provides a neural network model training apparatus, including: an initialization module, configured to: initialize an information processing neural network model and a reference neural network model corresponding to the information processing neural network model, the information processing neural network model including a plurality of processing modules, and the reference neural network model including a plurality of reference modules; and a parameter updating module, configured to: update a parameter of the information processing neural network model and a parameter of the reference neural network model through a plurality of iterations: in each iteration, determine output results respectively corresponding to the plurality of reference modules based on a training sample and parameters of the plurality of reference modules; determine output results respectively corresponding to the plurality of processing modules based on a masked sample obtained after performing mask processing on the training sample and parameters of the plurality of processing modules; update the parameters of the plurality of processing modules based on the output results respectively corresponding to the plurality of processing modules and the output results respectively corresponding to the plurality of reference modules; and update the parameters of the plurality of reference modules based on updated parameters of the plurality of processing modules.

An embodiment of the present disclosure further provides an information processing method based on a neural network model, including: obtaining to-be-processed information, the to-be-processed information including at least one of image information, text information, audio information, and video information; and processing the to-be-processed information based on an information processing neural network model, to obtain a processing result of the to-be-processed information, the information processing neural network model being obtained by training through the above neural network model training method.

An embodiment of the present disclosure further provides a computer program product, the computer program product including a computer software code, and the computer software code, when executed by a processor, providing the above method.

An embodiment of the present disclosure further provides a computer-readable storage medium, having a computer-executable instruction stored therein, the instruction, when executed by a processor, providing the above method.

According to the neural network model training method of the present disclosure, each processing module in the information processing neural network model can be trained separately, and the processing modules can be trained in parallel, thereby effectively improving efficiency of training the neural network model.

In the neural network model training method of the present disclosure, a processing module can be trained based only on an output result of the processing module and an output result of a reference module corresponding to the processing module. Gradients of a loss function with respect to parameters of other processing modules do not need to be clarified in this process. Therefore, difficulty of training the neural network model is lowered; computer resources can be effectively saved; and a requirement on computer performance can be reduced.

In addition, since each processing module in the information processing neural network model can be independently trained, and the processing modules do not need to share their own network parameters, the neural network model training method of the present disclosure has good confidentiality, and can better protect the parameter of each processing module and prevent the parameter from being stolen. Therefore, the neural network model training method of the present disclosure has significant advantages to an application scenario (for example, related to trade secrets and personal privacy) having a high requirement for confidentiality.

The neural network model training method of the present disclosure can effectively reduce an amount of calculations performed by a computer and fully use computer resources to implement parallel training on a plurality of processing modules, thereby reducing training time of the neural network model. The neural network model training method of the present disclosure can separately train each processing module, and has high training efficiency. Therefore, the method can be better applied to a training scenario for a large neural network model or a real-time training scenario for a neural network model (namely, training is performed while a task is processed, instead of a task processing process being completely independent from a training process).

In addition, compared with an existing neural network model training method based on backward propagation, the neural network model training method of the present disclosure can stably train a neural network model and effectively avoid a collapse problem in a neural network training process.

### BRIEF DESCRIPTION OF THE DRAWINGS

To describe technical solutions in the embodiments of the present disclosure more clearly, the following briefly describes accompanying drawings required for describing the embodiments. Apparently, the accompanying drawings in the following description show only some embodiments of the present disclosure, and a person of ordinary skill in the art may still derive other drawings from these accompanying drawings without creative work.

Here, in the accompanying drawings:

FIG. 1 is a schematic diagram of an application scenario according to an embodiment of the present disclosure.

FIG. 2 is a schematic diagram of an example of a scenario of information processing and training based on a neural network model according to an embodiment of the present disclosure.

FIG. 3A is a schematic flowchart of a neural network model training method according to an embodiment of the present disclosure

FIG. 3B is another schematic flowchart of a neural network model training method according to an embodiment of the present disclosure.

FIG. 4A is a schematic diagram of a process of processing a training sample according to an embodiment of the present disclosure.

FIG. 4B is another schematic diagram of a process of processing a training sample according to an embodiment of the present disclosure.

FIG. 4C is another schematic diagram of a process of processing a training sample according to an embodiment of the present disclosure.

FIG. 4D is another schematic diagram of a process of processing a training sample according to an embodiment of the present disclosure.

FIG. 4E is another schematic diagrams of a process of processing a training sample according to an embodiment of the present disclosure.

FIG. 5 is a schematic diagram of a process of training a neural network model according to an embodiment of the present disclosure.

FIG. 6 is a schematic flowchart of an information processing method based on a neural network model according to an embodiment of the present disclosure.

FIG. 7 is a schematic diagram of an information processing process based on a neural network model according to an embodiment of the present disclosure.

FIG. 8 is a schematic diagram of constitution of a neural network model training apparatus according to an embodiment of the present disclosure.

FIG. 9 is a schematic diagram of constitution of an information processing apparatus based on a neural network model according to an embodiment of the present disclosure.

FIG. 10 is an architecture of a computing device according to an embodiment of the present disclosure.

### DESCRIPTION OF EMBODIMENTS

To make objectives, technical solutions, and advantages of the present disclosure more apparent, the following further describes in detail exemplary embodiments of the present disclosure with reference to the accompanying drawings. Apparently, the described embodiments are merely some embodiments of the present disclosure rather than all embodiments of the present disclosure. The present disclosure is not limited by the exemplary embodiments described herein.

In addition, in this specification and the accompanying drawings, operations and elements that are essentially the same or similar are represented by identical or similar reference numerals, and repeated descriptions of these operations and elements will be omitted.

In addition, in this specification and the accompanying drawings, according to the embodiments, elements are described in a singular or plural form. However, the appropriate selection of the singular and plural forms for proposed situations is only for the convenience of explanation and is not intended to limit the present disclosure. Therefore, the singular form can include the plural form, and the plural form can also include the singular form, unless the context explicitly states otherwise.

In the specification and accompanying drawings, operations and elements that are basically the same or similar are represented by the same or similar reference signs, and repeated descriptions of these operations and elements are omitted. In addition, in the descriptions of the present disclosure, the terms “first”, “second”, and the like are only for the purpose of distinguishing the description, and may not be understood as indicating or implying the relative importance or a sequence.

The following various neural networks (or neural network models) that can be used in the embodiments of the present disclosure may all be artificial intelligence models, and in particular, may be artificial-intelligence-based neural network models. Usually, the artificial-intelligence-based neural network model is implemented as an acyclic graph, in which neurons are arranged on different layers. Usually, the neural network model includes an input layer and an output layer. The input layer and the output layer are separated through at least one hidden layer. The hidden layer transforms an input received by the input layer into a representation useful for generating an output in the output layer. A network node (i.e. a neuron) is fully connected to a node in an adjacent layer via an edge, and there is no edge between nodes in each layer. Data received at a node of the input layer of the neural network is propagated to a node of the output layer through any one of a hidden layer, an activation layer, a pooling layer, a convolutional layer, or the like. An input and an output of the neural network model may use various forms. The present disclosure does not limit this.

In the present disclosure, considering that lack of reasonability and local plasticity in backward propagation in a neural network model such as an SSL model is still a fundamental problem that is not solved, a new biologically proper algorithm is provided. The algorithm operates in a manner closer to satisfying a neural circuit constraint. Under a framework of an energy-based model using only local available information, all free variables in the provided model are autonomously optimized, to minimize a prediction masking and coding function for defining local and global energy. Therefore, crashing can be eliminated and pretraining can be stably facilitated. The technical solutions in the embodiments of the present disclosure may be applied to an SSL model, or may be applied to various neural network models such as a supervised model.

The following further describes the embodiments of the present disclosure with reference to the accompanying drawings.

First, an application scenario of a method and a corresponding apparatus according to an embodiment of the present disclosure is described with reference to FIG. 1. FIG. 1 is a schematic diagram of an application scenario 100 according to an embodiment of the present disclosure. A server 110 and a plurality of terminals 120 are shown as examples.

An information processing neural network model in this embodiment of the present disclosure may be specifically integrated into various electronic devices, for example, any electronic device of the server 110 and the plurality of terminals 120 in FIG. 1. For example, the information processing neural network model may be integrated in a terminal 120. The terminal 120 may be a smartphone, a tablet computer, a notebook computer, a desktop computer, a personal computer (PC), a smart speaker, a smart watch, or the like, but is not limited thereto. For another example, the information processing neural network model may be further integrated in the server 110. The server 110 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be directly or indirectly connected to the server in a wired or wireless communication protocol. This is not limited in the present disclosure.

An information processing apparatus based on a neural network model that uses this embodiment of the present disclosure may be a terminal, or may be a server, or may be a system composed of a terminal and a server. The information processing method applying this embodiment of the present disclosure may be performed on the terminal or the server, or may be performed jointly on the terminal or the server.

The information processing neural network model provided in this embodiment of the present disclosure may be configured for executing various information processing tasks, including: information extraction (for example, key information extraction, information search, and feature extraction), information classification (for example, image classification, disease diagnosis, and junk information recognition), information restoration (for example, image inpainting and incomplete information prediction), information style transfer (for example, image style transfer and tone shift), information enhancement (for example, image definition enhancement and audio denoising), information mining (for example, big data mining and network information mining), information recognition (for example, disease diagnosis and junk information recognition), machine translation, and the like, and is not limited thereto. In the present disclosure, the information processed based on the neural network model may include: an image, a text, an audio, a video, an array, and the like.

The information processing neural network model provided in this embodiment of the present disclosure may further relate to an artificial intelligence cloud service in the field of cloud technologies. The cloud technology is a hosting technology that unifies a series of resources such as hardware, software, and network in a wide area network or a local area network, to implement computing, storage, processing, and sharing of data. The cloud technology is a generic term of a network technology, an information technology, an integration technology, a management platform technology, and an application technology based on application of a cloud computing business model. The resources may form a resource pool and are used on demand, which is flexible and convenient. A cloud computing technology will become an important support. The background service of a technical network system requires many computing and storage resources, for example, video websites, image websites, and more portal websites. With the rapid development and application of the Internet industry, each item may have its own recognition mark in the future, and the recognition marks need to be transmitted to a backend system for logical processing. Data of different levels is processed separately, and all kinds of industry data require strong system support, which can be achieved only through cloud computing.

The artificial intelligence cloud service is generally also referred to as AI as a Service (AIaaS). This is a current mainstream service manner of an artificial intelligence platform. Specifically, the AIaaS platform splits several types of common AI services, and provides independent or packaged services on a cloud. This service mode is similar to opening an AI theme store. All developers may access, by using an application programming interface (API), one or more artificial intelligence services provided by the platform. Some senior developers may further use an AI framework and an AI infrastructure that are provided by the platform to deploy, operate, and maintain an exclusive cloud artificial intelligence service.

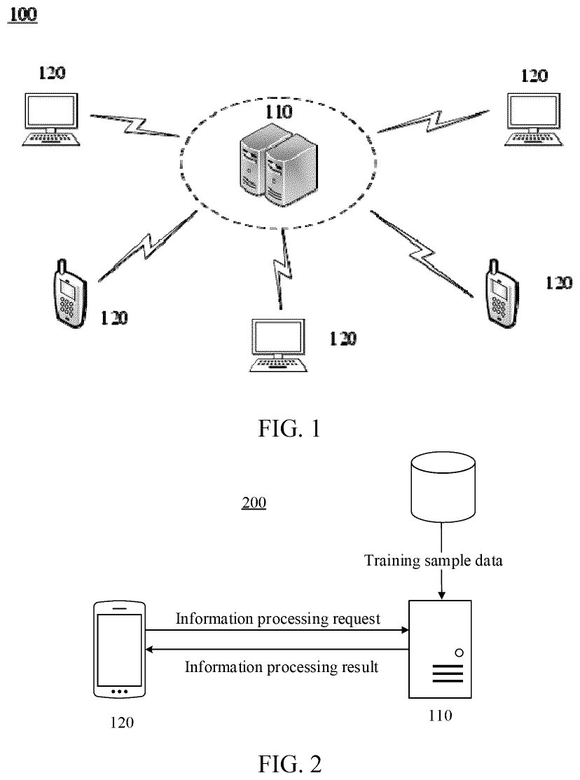

FIG. 2 is a schematic diagram of an example of a scenario 200 of information processing and training based on a neural network model according to an embodiment of the present disclosure.

In a training stage, the server 110 may train a neural network model based on a training sample. After the training is completed, the server may deploy the neural network model on which training is completed to one or more servers (or a cloud service), to provide an artificial intelligence service related to information processing based on the neural network model. All training samples used in the present disclosure satisfy validity, morality, and privacy that are stipulated by laws and regulations. Specifically, sources of all the training samples are valid, and have been explicitly approved by a user in an acquisition process. In addition, all the training samples used in the present disclosure comply with a privacy protection principle. The training samples have been strictly filtered and cleaned, and are not leaked to any third party that is not explicitly authorized.

In a stage of performing information processing based on the neural network model, it is assumed that a client or an application (for example, an image processing application or a text processing application) that interacts with the server 110 for information processing has been already installed on a user terminal 120 that performs information processing. The user terminal 120 may transmit, through a network, an information processing request to the server 110 corresponding to the application, to request a neural network deployed on the server 110 to process information. For example, after receiving the information processing request, the server 110 uses the neural network model on which training is completed to perform information processing in response to the information processing request, and feeds back a predicted information processing result to the user terminal 120. The user terminal 120 may receive the information processing result. Then, the user terminal 120 may perform further analysis or processing based on the information processing result.

Training sample data shown in FIG. 2 may be updated in real time. For example, a user may score the information processing result. For example, if the user considers that both the properness and accuracy of the information processing result are high, the user may provide a high score for the information processing result, and the server 110 may use the information processing result as a positive sample for training the neural network model in real time. If the user provides a low score for the information processing result, the server 110 may use the information processing result as a negative sample.

A training sample set shown in FIG. 2 may be set in advance. For example, referring to FIG. 2, the server may obtain training data (such as an image training sample, a text training sample, an audio training sample, or a video training sample) from a database, and then generate a training sample set for the neural network model. Certainly, the present disclosure is not limited thereto.

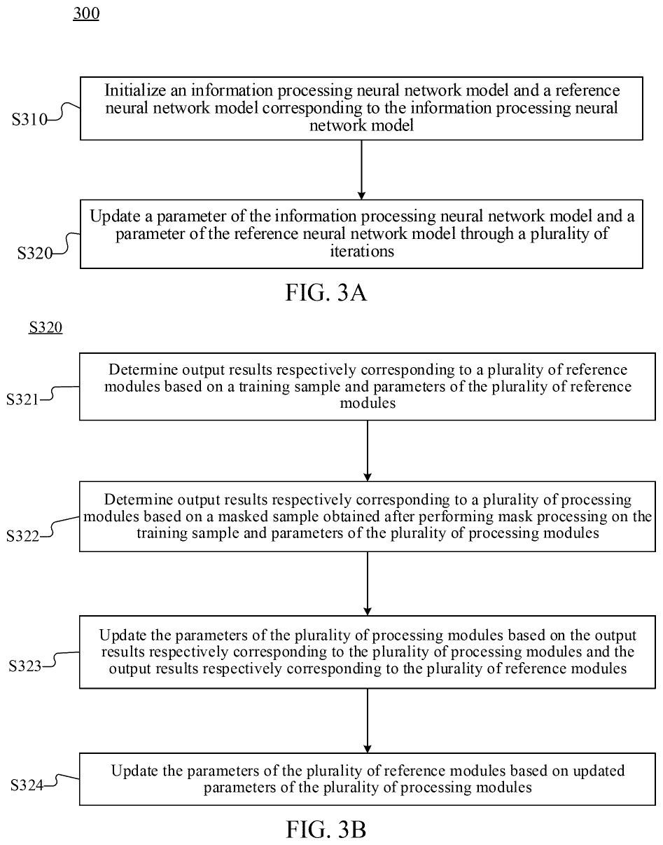

FIG. 3A is a schematic flowchart of a neural network model training method 300 according to an embodiment of the present disclosure.

Operation S310: Initialize an information processing neural network model and a reference neural network model corresponding to the information processing neural network model. In an example, a relationship between the reference neural network model and the information processing neural network model may be understood as a relationship between a teacher model and a student model in a knowledge distillation learning process. A function of setting a reference neural network is to obtain a target that needs to be learned by an information processing neural network, to implement training on the information processing neural network and stabilize the training on the information processing neural network and prevent collapse. In an implementation, a structure and parameter of the reference neural network model corresponding to the information processing neural network model may be determined based on a structure and parameter of the information processing neural network model.

Here, the information processing neural network model in the present disclosure may include a plurality of processing modules, and the reference neural network model may include a plurality of reference modules.

According to this embodiment of the present disclosure, the plurality of processing modules may be L processing modules. The plurality of reference modules may be L reference modules. An l^{th} processing module among the L processing modules and an l^{th} reference module among the L reference modules have the same structures, where L and l are positive integers, and l≤L.

Each of the plurality of processing modules may have the same structure or function as or a different structure or function from other processing modules. Similarly, each of the plurality of reference modules may have the same structure or function as or a different structure or function from other reference modules.

According to this embodiment of the present disclosure, an initial parameter of the information processing neural network model and an initial parameter of the reference neural network model may be determined based on a random number, or an initial parameter of the information processing neural network model and an initial parameter of the reference neural network model may be determined based on experience of a skilled person. The initial parameter of the information processing neural network model and the initial parameter of the reference neural network model may be the same or different. In some embodiments, the information processing neural network model may be pre-trained for a preset number of times. Then, a parameter of the pre-trained information processing neural network model is used as an initial parameter of the reference neural network model.

Here, each of the plurality of processing modules or each of the plurality of reference modules is a sub-neural network model or a neural network layer. For example, each processing module or each reference module may include: a convolutional neural network, an attention-mechanism-based neural network, a recurrent neural network, a recursive neural network, a feedforward neural network, a generative adversarial neural network, a deep neural network, or the like.

Operation S320: Updating a parameter of the information processing neural network model and a parameter of the reference neural network model through a plurality of iterations.

To describe operation S320 more clearly, FIG. 3B further shows processing operation in each iteration. As shown in FIG. 3B, operation S320 may specifically include operation S321, operation S322, operation S323, and operation S324.

Operation S321: Determine output results respectively corresponding to the plurality of reference modules based on a training sample and parameters of the plurality of reference modules. In an example, a specific process of determining the output results respectively corresponding to the plurality of reference modules may be: inputting the training sample to the plurality of reference modules for forward calculation, and outputting corresponding calculation results. The process may not include gradient backward propagation, so that the parameters of the reference modules in the process may be constant.

The training sample may include one or more of an image training sample, a text training sample, an audio training sample, and a video (in some embodiments, the video may be processed into an image and an audio) training sample.

Operation S322: Determine output results respectively corresponding to the plurality of processing modules based on a masked sample obtained after performing mask processing on the training sample and parameters of the plurality of processing modules. In an example, a specific process of determining the output results respectively corresponding to the plurality of processing modules may be: inputting the masked sample to the plurality of processing modules for forward calculation, and outputting corresponding calculation results. The process may not include gradient backward propagation either, so that the parameters of the processing modules in the process may be constant.

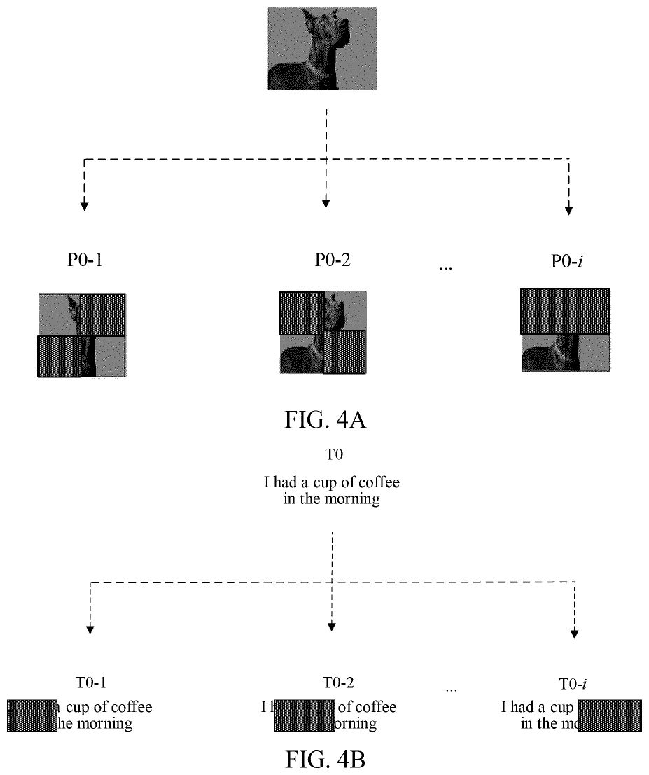

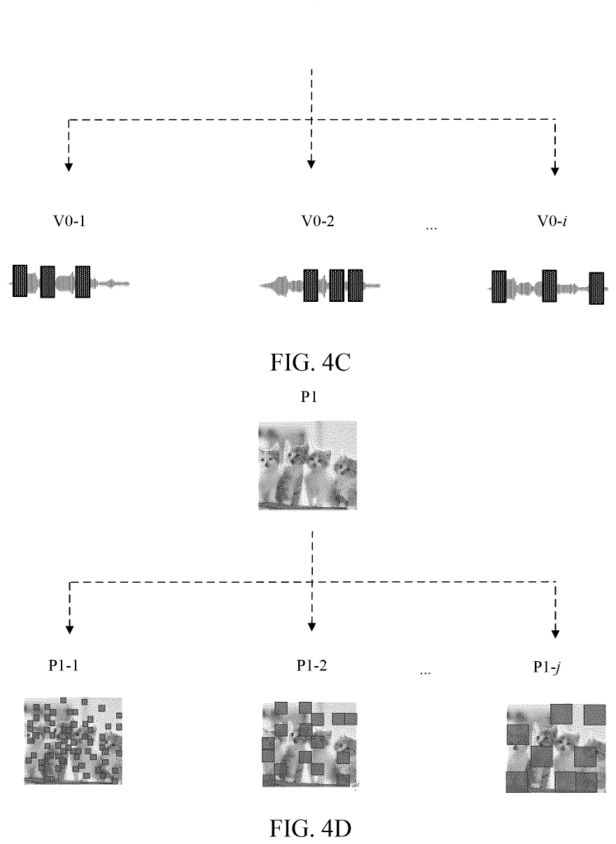

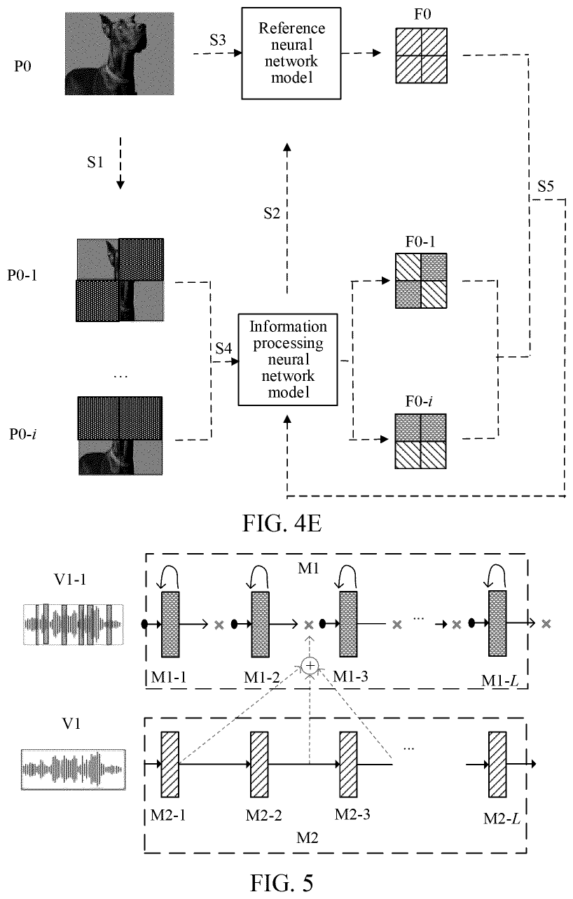

For example, an image training sample in FIG. 4A is used as an example. A masked sample P0-1, a masked sample P0-2, . . . , and a masked sample P0-i that have different mask positions may be further obtained by performing mask processing on an image training sample P0. A text training sample in FIG. 4B is used as an example. A masked sample T0-1, a masked sample T0-2, . . . , and a masked sample T0-i that have different mask positions may be further obtained by performing mask processing on a text training sample T0 . An audio training sample in FIG. 4C is used as an example. A masked sample V0-1, a masked sample V0-2, . . . , and a masked sample V0-i that have different mask positions may be further obtained by performing mask processing on an audio training sample V0 . For the examples in FIG. 4A to FIG. 4C, i is a positive integer.

According to this embodiment of the present disclosure, the performing mask processing on the training sample may include: performing mask processing with different sizes (such as sizes and lengths), mask processing with different positions, mask processing with different shapes (such as a square shape, a round shape, and an irregular shape), and the like on the training sample. For example, an image training sample shown in FIG. 4D is used as an example. By performing mask processing on an image training sample P1, a masked sample P1-1, a masked sample P1-2, . . . , and a masked sample P1-j that have different mask sizes and different positions may be further obtained, where j is a positive integer.

Diversity of masked samples processed by the processing modules can be increased by performing different mask processing on the training sample, thereby improving performance of the trained processing modules. Therefore, a more accurate processing result can be obtained based on the trained processing module.

Operation S323: Update the parameters of the plurality of processing modules based on the output results respectively corresponding to the plurality of processing modules and the output results respectively corresponding to the plurality of reference modules.

According to this embodiment of the present disclosure, for the l^{th} processing module among the L processing modules, the parameter of the l^{th} processing module may be updated based on the output result of the l^{th} processing module and the output result of a reference module corresponding to the l^{th} processing module.

Here, the reference module corresponding to the l^{th} processing module may be an l^{th} reference module among the L reference modules, but is not limited to this. In some embodiments, the reference module corresponding to the l^{th} processing module may include one or more reference modules around the l^{th} reference modules. For example, the reference module corresponding to the l^{th} processing module includes reference modules from an (l−m)^{th} reference module to an (l+n)^{th} reference module, where m and n are integers and satisfy m≥0, n≥0, l−m≥1, and l+n≤L. Values of m and n may be the same or different.

According to this embodiment of the present disclosure, a value of an energy function may be calculated based on the output results respectively corresponding to the plurality of processing modules and the output results respectively corresponding to the plurality of reference modules, and the parameters of the plurality of processing modules may be updated based on the value of the energy function, the energy function being configured for evaluating accuracy of the output results of the plurality of processing modules.

The energy function may be a global energy function (namely, a global optimization goal of all the processing modules) for evaluating a difference between the output result of an L^{th} processing module and the output result of an L^{th} reference module, or may be a local energy function (namely, an optimization goal of a single processing module) for evaluating a difference between the output result of the l^{th} processing module and the output result of the reference module corresponding to the l^{th} processing module. In some embodiments, the energy function may be further determined based on both the global energy function and the local energy function (for example, by adding the global energy function and the local energy function, calculating an average, calculating weighted average, or the like).

According to this embodiment of the present disclosure, the energy function (whether the energy function is the global energy function or the local energy function) may have diversified forms.

For example, for the l^{th} processing module among the L processing modules, a value of a first local energy function may be determined based on the difference between the output result of the l^{th} processing module and the output result of the reference module corresponding to the l^{th} processing module.

In addition, an expected output result of the l^{th} processing module may be further determined based on the global energy function. In addition, a value of a second local energy function may be determined based on a difference between the output result of the l^{th} processing module and an expected output result of the l^{th} processing module.

Specifically, in the process of determining the expected output result of the l^{th} processing module based on the global energy function, a backward calculation difference of the output result of the l^{th} processing module may be determined based on the global energy function. Then, the expected output result of the l^{th} processing module may be determined based on the backward calculation difference of the output result of the l^{th} processing module and the output result of the l^{th} processing module. The backward calculation difference of the output result of the l^{th} processing module is obtained by propagating the difference between the output result of the L^{th} processing module and the output result of the L^{th} reference module to the l^{th} processing module in sequence.

For example, for an (l+k)^{th} processing module among the processing modules from the L^{th} processing module to the l^{th} processing module, a partial derivative of the output result of the (l+k)^{th} processing module with respect to an output result of an (l+k−1)^{th} processing module may be calculated (the output result of the (l+k−1)^{th} processing module is an input of the (l+k)^{th} processing module). Then, a backward calculation difference of the output result of the (l+k)^{th} processing module may be determined based on the partial derivative and a backward calculation difference of an output result of an (l+k+1)^{th} processing module, where k is an integer and satisfying: k≥0, l+k+1≤L.

According to this embodiment of the present disclosure, a comprehensive local energy function may be determined based on different local energy functions, and the parameter of the l^{th} processing module may be updated based on this comprehensive local energy function.

For example, a third local energy function may be determined based on the first local energy function and the second local energy function mentioned above, and the parameter of the l^{th} processing module may be updated based on the third local energy function. In an implementation, the third local energy function may be determined by performing weighting calculation on the first local energy function and the second local energy function.

According to this embodiment of the present disclosure, the parameter of the l^{th} processing module may alternatively be updated based on different local energy functions in different situations.

For example, the parameter of the l^{th} processing module may be updated based on the value of the first local energy function corresponding to the l^{th} processing module when the first local energy function corresponding to the l^{th} processing module does not converge (namely, an optimization goal of a single processing module is considered only). In addition, the parameter of the l^{th} processing module may be updated based on the second local energy function (which is determined based on the global energy function) corresponding to the l^{th} processing module when the first local energy function corresponding to the l^{th} processing module converges (namely, a global optimization goal of all the processing modules is considered).

Operation S324: Update the parameters of the plurality of reference modules based on updated parameters of the plurality of processing modules.

According to this embodiment of the present disclosure, the parameters of the plurality of reference modules may be updated by using values of the parameters of the plurality of processing modules in at least one previous iteration. For example, the parameters of the plurality of reference modules may be updated by using an exponential moving average of the parameters of the plurality of processing modules in the at least one previous iteration. To be specific, assuming that the updated parameter of a processing module is W and the parameter of a current reference module is W̅, an updated parameter of the reference module may be: τW̅+(1−τ)W, where 0≤τ≤1. In addition, an arithmetic mean or a weighted average (in some embodiments, a weight of a latest parameter of a processing module may be set to be greater than a weight of the parameter before) of the parameters of the plurality of processing modules in the at least one previous iteration to update the parameters of the plurality of reference modules. The present disclosure is not limited to this.

The above neural network model training method 300 may be configured for performing supervised training on the information processing neural network model or performing self-supervised training on the information processing neural network model.

The image training sample shown in FIG. 4A is used as an example. When performing self-supervised training on the information processing neural network model, a process of processing the training sample may be shown in FIG. 4E.

In operation S1, mask processing with different positions may be performed on the image training sample P0 to obtain the masked sample P0-1, . . . , and the masked sample P0-i. In some embodiments, the mask processing may alternatively be performed on the training sample according to information included in the image training sample. For example, for an information processing neural network for recognizing a person in an image, mask processing with a finer granularity may be performed on a part at which the person in the image is located (for example, each mask size is smaller), and mask processing with a coarser granularity may be performed on a part at which a surrounding environment is located (for example, each mask size is larger), so that the trained neural network model focuses on learning characteristics of the person.

In operation S2, a structure and parameter of the reference neural network model corresponding to the information processing neural network model may be determined based on a structure and parameter of the information processing neural network model. For example, structures of the processing modules in the information processing neural network model may be in one-to-one correspondence to structures of the reference modules in the reference neural network model, and may extract image features. A difference is that the reference neural network model extracts an image feature based on the complete image training sample P0, and the information processing neural network model extracts an image feature based on the masked samples. The parameters of the reference modules in the reference neural network model may be determined based on historical results of the parameters of the processing modules corresponding to the reference modules. For example, before the information processing neural network model is trained based on the reference neural network model, supervised training may be performed for a preset number of times (for example, 50 times, but not limited thereto) on the information processing neural network model separately by using a labeled image training sample (Herein, each instance of training among the preset number of instances of supervised training means training of an epoch, rather than training of a batch). Then, the parameter of the information processing neural network model that is updated for the preset number of times is used as an initial parameter of the reference neural network model, and the information processing neural network model is then trained based on the reference neural network model, so as to update the parameter of the information processing neural network model and the parameter of the reference neural network model. In the process of training the information processing neural network model, once the parameter of the information processing neural network model is updated, the updated parameters of the processing modules are also used to update the parameters of the reference modules corresponding to the processing modules.

In operation S3, forward processing may be performed on the image training sample P0 by using the reference neural network model, to obtain a feature representation F0 of the image training sample P0.

Meanwhile, in operation S4, forward processing may be performed on the masked sample P0-1, . . . , and the masked sample P0-i by using the information processing neural network model, to predict and obtain predicted feature representations F0-1, . . . , F0-i of the image training sample P0 based on the masked sample P0-1, . . . , and the masked sample P0-i. Here, a predicted feature representation includes two parts, namely, a feature representation for an unmasked part (i.e. a part filled with an oblique line texture in a masked sample shown in FIG. 4E) and a feature representation for a masked part (i.e. a part filled with a dotted texture in a masked sample shown in FIG. 4E).

Here, the reference neural network model may perform feature coding on the complete image training sample P0, to obtain a complete feature representation F0 of the image training sample P0. The information processing neural network model performs feature coding on the masked samples, so that only the feature representations of the unmasked parts may be obtained first. The feature representations of the masked parts are then decoded and predicted based on the feature representations of the unmasked parts, so as to obtain the predicted feature representations of the image training sample P0.

Then, in operation S5, the energy function may be calculated based on differences between output results (namely, the feature representations F0-1, . . . , and F0-i of the masked sample P0-1, . . . , and the masked sample P0-i) corresponding to the information processing neural network model and an output result (namely, the feature representation F0 of the image training sample P0) corresponding to the reference neural network model, and the parameter of the information processing neural network model is updated based on the value of the energy function.

In this embodiment of FIG. 4E, the information processing neural network model may be configured for extracting an image feature or predicting (or retouching) a faulty part of an image. In the processing process shown in FIG. 4E, the information processing neural network model may be trained by predetermining the image training sample and the structure of the information processing neural network model. This process does not need to provide a label of the training sample, so that time and labor costs are not required to label the training sample. It greatly improves processing efficiency of a neural network model for image processing. For example, in a process of training a neural network model for medical image processing, labeling the medical image may be implemented only by a professional doctor by careful determination. Labeling efficiency is low. By using the method of the present disclosure, labeling costs can be effectively reduced, and model training efficiency can be improved.

According to the examples of FIG. 4A and FIG. 4E, the present disclosure further discloses a method for training a neural network model for image processing. In some embodiments, the neural network model for image processing is an example of the above information processing neural network model. The method includes: initializing the neural network model for image processing and a reference neural network model corresponding to the neural network model for image processing, the neural network model for image processing including a plurality of processing modules, and the reference neural network model including a plurality of reference modules; updating a parameter of the neural network model for image processing and a parameter of the reference neural network model through a plurality of iterations: in each iteration, determining image features respectively corresponding to the plurality of reference modules based on an image training sample and parameters of the plurality of reference modules; determining image features respectively corresponding to the plurality of processing modules based on a masked sample obtained after performing mask processing on the image training sample and parameters of the plurality of processing modules; updating the parameters of the plurality of processing modules based on the image features respectively corresponding to the plurality of processing modules and the image features respectively corresponding to the plurality of reference modules; and updating the parameters of the plurality of reference modules based on updated parameters of the plurality of processing modules. Then, in some embodiments, features of image data may be extracted by using a trained neural network model for image processing, to further complete a face recognition task, a disease diagnosis and treatment task, or the like.

Still further, in a case that there is a predetermined training sample label, supervised training may be performed on the information processing neural network model by a process similar to the process in FIG. 4E. To be specific, the method 300 is applicable to both supervised training and self-supervised training. In a case that the supervised training is performed on the information processing neural network model, the global energy function may be determined based on a difference between the output result of the L^{th} processing module and the predetermined training sample label (namely, a result that is to be outputted by the L^{th} processing module).

In a case that the updated information processing neural network model satisfies a predetermined condition (for example, the energy function converges or a preset number of instances of training are completed), it may be determined that the training on the information processing neural network model is completed and a trained information processing neural network model is obtained. In this case, the trained information processing neural network model may be configured for extracting a feature (of an image, text, an audio, a video, or multimedia information), predicting missing information (including at least one of the image, the text, the audio, the video, or the multimedia information), and the like.

In some embodiments, the trained information processing neural network model may be further trained by using an information processing training sample corresponding to an information processing task (for example, finely adjusting the structure and parameter of the information processing neural network model), to complete a downstream information processing task such as information extraction, information classification, information restoration, information style transfer, information augmentation, information mining, and information recognition.

FIG. 5 is a schematic diagram of a process of training a neural network model according to an embodiment of the present disclosure.

FIG. 5 uses an audio training sample V1 as an example to describe the process of training an information processing neural network model. Mask processing may be performed on the audio training sample V1 in a manner shown in FIG. 4C, to obtain a plurality of different masked samples V1-1, V1-2, . . . , and V1-j, j being a positive integer. Only the masked sample V1-1 is used as an example for description in FIG. 5. Processes of training the information processing neural network model by using other masked samples are similar to the process shown in FIG. 5, and will not be elaborated here.

As shown in FIG. 5, an information processing neural network model M1 includes L processing modules (shown by blocks M1-1, M1-2, . . . , and M1-L that are filled with dotted textures in FIG. 5). Based on the information processing neural network model M1 including the L processing modules, a reference neural network model M2 including L reference modules (shown by blocks M2-1, M2-2, . . . , M2-L that are filled with oblique line textures in FIG. 5) may be determined, L being a positive integer. Each processing module and each reference module in FIG. 5 may have the same network structures.

For example, each reference module may include a neural network layer such as an attention-mechanism-based neural network layer, a fully-connected layer, and a linear layer, to jointly implement feature extraction on the audio training sample V1. Each reference module may use the same network structure. Similarly, each processing module may include a neural network layer that is the same as that of each reference module, such as an attention-mechanism-based neural network layer, a fully-connected layer, and a linear layer, to jointly implement feature extraction on the masked audio training sample V1-1. Each reference module may use the same network structure, namely, the same network structure as each processing module.

For the example in FIG. 5, the information processing neural network model M1 includes the L processing modules that have the same structures and are configured for feature extraction, so as to more accurately obtain features of the audio training sample. Actually, each processing module is already a complete sub-neural network, and may be configured to: obtain the features of the audio training sample and predict information of a missing part in a case that partial content of the audio training sample is missing.

In some embodiments, each of the L processing modules or each of the L reference modules may have different network structures according to a need.

In the information processing neural network model M1, an input of an l^{th} processing module may be represented as xₗ (shown by a black filled dot in FIG. 5), and an output may be represented as f(xₗ, Wₗ), where x represents a feature vector; Wₗ is a network parameter of the l^{th} processing module; l is a positive integer; and l≤L. In addition, in the example of FIG. 5, the processing modules are in a serial connection relationship. To be specific, the output of the l^{th} processing module is an input of an (l+1)^{th} processing module, namely, xₗ₊₁=f(xₗ, Wₗ).

Similarly, in the reference neural network model M2, an input of an l^{th} reference module may be represented as x″ₗ, and an output may be represented as

$$f ( {x}_{l}^{″} , {\overline{W}}_{l} ) ,$$

where f(⋅) is a forward propagation function; W̅ₗ is a network parameter of the l^{th} reference module; l is a positive integer; and l≤L. In addition, in the example of FIG. 5, the reference modules are in a serial connection relationship. To be specific, the output of the l^{th} reference module is an input of an (l+1)^{th} reference module, namely,

$${x}_{l + 1}^{″} = f ( {x}_{l}^{″} , {\overline{W}}_{l} ) .$$

For this embodiment shown in FIG. 5, each processing module may be trained separately, instead of calculating forward calculation results of the processing modules, sequentially obtaining gradients of a loss function with respect to parameters of the processing modules through backward calculation, and then updating a parameter of an entire neural network according to the gradients.

For example, for the l^{th} processing module among the L processing modules, the l^{th} processing module may be trained based on an output result of the l^{th} processing module and an output result of a reference module corresponding to the l^{th} processing module, and a parameter of the l^{th} processing module may be updated.

As shown in FIG. 5, the reference module corresponding to the l^{th} processing module may include the l^{th} reference module and reference modules around the l^{th} reference module. For example, the reference module corresponding to the l^{th} processing module includes an (l−1)^{th} reference module, the l^{th} reference module, and an (l+1)^{th} reference module, where l−1≥1, l+1≤L. A reference module corresponding to a first processing module may include a first reference module. A reference module corresponding to an L^{th} processing module may include an L^{th} reference module. In some embodiments, a reference module corresponding to a first processing module may include a first reference module and one or more reference modules behind the first processing module. A reference module corresponding to an L^{th} processing module may include an L^{th} reference module and one or more reference modules in front of the L^{th} reference module.

An output reference result x′ₗ₊₁ (shown by a cross in FIG. 5) may be determined based on the output result of the reference module corresponding to the l^{th} processing module, to train the l^{th} processing module. For example, in a case that the reference module corresponding to the l^{th} processing module includes the (l−1)^{th} reference module, the l^{th} reference module, and the (l+1)^{th} reference module, an average or a weighted average of an output result of the (l−1)^{th} reference module, an output result of the l^{th} reference module, and an output result of the (l+1)^{th} reference module may be solved (for example, a weight of the output result of the l^{th} reference module may be set to be greater than weights of the output results of the other two reference modules), to determine a reference result

$${x}_{l}^{′}$$

corresponding to the l^{th} processing module.

Then, an energy function may be determined based on an output reference result

$${x}_{l + 1}^{′}$$

corresponding to the l^{th} processing module and an output xₗ₊₁=f(xₗ, Wₗ) of the l^{th} processing module, to train the l^{th} processing module.

The energy function E corresponding to the entire information processing neural network model may be calculated through formula (1):

$$E = {E}_{local} + λ {E}_{global} \qquad ( 1 )$$

where E_{local} represents local energy, and there is

$${E}_{local} = {\sum }_{l = 1}^{L} {E}_{local , l} ,$$

where E_{local,l} represents local energy corresponding to the l^{th} processing module; E_{global} represents a global energy function; and λ represents an impact degree of global energy on total energy, 0<λ≤1. In situations where only an optimization goal of a single processing module is considered, λ=0.

According to this embodiment of the present disclosure, to train each processing module separately, the l^{th} processing module may be trained by using a local energy function corresponding to the l^{th} processing module. The local energy function corresponding to the l^{th} processing module is configured for evaluating a difference between the output result of the l^{th} processing module and the output result of the reference module corresponding to the l^{th} processing module.

For example, considering a local optimization goal of the l^{th} processing module and a local optimization goal affected by a global optimization goal of all the processing modules, the local energy function E_{local,l} corresponding to the l^{th} processing module may be calculated through formula (2):

$$2 {E}_{local , l} = \frac{1}{\sqrt{D}} {\sum }_{B \times T} {λ}_{PM} {‖ {x}_{l + 1}^{′} - Dec ( {x}_{l + 1} ) ‖}_{2}^{2} + {λ}_{PC} {‖ f ( {x}_{l} , {W}_{l} ) - {x}_{l + 1}^{*} ‖}_{2}^{2} \qquad ( 2 )$$

where B represents a batch processing size; T represents a masked frame (For the sake of simplicity, the subscript is omitted here); L represents a dimension of a feature vector x; Dec(⋅) represents a feature representation predicted by a masked part;

$${x}_{l + 1}^{*}$$

represents an expected output result of the l^{th} processing module; and values of λ_{PM} and λ_{PC} are 0 or 1, and are opposite. In a case that λ_{PM} is 1 (namely, only the optimization goal of the l^{th} processing module is considered), E_{local,l} (represented by using a first local energy function later) represents a difference between a feature representation obtained by predicting a masked part by the l^{th} processing module and a feature representation obtained by coding the masked part by the l^{th} reference module. In a case that λ_{PC} is 1 (namely, the global optimization goal of all the processing modules is considered), E_{local,l} (represented by using a second local energy function later) represents a difference between the output result of the l^{th} processing module and an expected output result of the l^{th} reference module. The expected output result of the l^{th} reference module is determined based on the output result of the L^{th} processing module.

According to this embodiment of the present disclosure, the first local energy function corresponding to the l^{th} processing module may be first used to train the l^{th} processing module. Then, in a case that the first local energy function corresponding to the l^{th} processing module (in this case, it may be considered that

$$\frac{\partial {E}_{local , l}}{\partial {x}_{l}} = 0 )$$

converges, the parameter of the l^{th} processing module is updated based on the second local energy function.

As shown in formula (3), the second local energy function may be determined based on a calculation result of the global energy function E_{global} (namely, the difference between the feature representation Dec(x_{L+1}) obtained by predicting the masked part by the l^{th} processing module and the output result

$${x}_{L + 1}^{′}$$

of the L^{th} reference module). The second local energy function reflects the global optimization goal of all the processing modules.

$${E}_{global} = \frac{1}{\sqrt{D}} {\sum }_{BxT} {‖ {x}_{L + 1}^{′} - Dec ( {x}_{L + 1} ) ‖}_{2}^{2} \qquad ( 3 )$$

The above expected output result

$${x}_{l + 1}^{*}$$

of the l^{th} processing module may be determined based on the global energy function E_{global}. For example, the expected output result

$${x}_{l + 1}^{*}$$

of the l^{th} processing module may be determined through the following process.

In a case that the local energy function converges, the energy function has a characteristic shown in formula (4):

$$\frac{dx}{dt} = - \frac{\partial E}{\partial x} = - \frac{\partial {E}_{local}}{\partial x} - λ \frac{\partial {E}_{global}}{\partial x} = - λ \frac{\partial {E}_{global}}{\partial x} \qquad ( 4 )$$

Therefore, it may be obtained that for the l^{th} processing module,

$$\frac{{dx}_{l}}{dt} = - \frac{\partial E}{\partial {x}_{l}} = - {ε}_{l + 1} \frac{\partial f ( {x}_{l} , {W}_{l} )}{\partial {x}_{l}} \qquad ( 5 )$$

where εₗ₊₁ represents a backward calculation difference. Backward calculation means that starting from the L^{th} processing module, calculation is performed forwards in sequence (namely, according to an order of the L^{th} processing module, an (L−1)^{th} processing module, . . . , the l^{th} processing module).

Further, the backward calculation difference may be sequentially determined for each of the processing modules from the L^{th} processing module to the l^{th} processing module, so that the difference of the L^{th} processing module may be propagated to the l^{th} processing module.

For example, for an (l+k)^{th} processing module among the processing modules from the L^{th} processing module to the l^{th} processing module, a partial derivative

$$\frac{\partial f ( {x}_{l + k} , {W}_{l + k} )}{\partial {x}_{l + k}}$$

of the output result f(xₗ₊ₖ, Wₗ₊ₖ) of the (l+k)^{th} processing module with respect to an output result xₗ₊ₖ of an (l+k−1)^{th} processing module may be calculated. Then, a backward calculation difference εₗ₊ₖ of the output result of the (l+k)^{th} processing module may be determined based on the partial derivative

$$\frac{\partial f ( {x}_{l + k} , {W}_{l + k} )}{\partial {x}_{l + k}}$$

and a backward calculation difference εₗ₊ₖ₊₁ of an output result of an (l+k+1)^{th} processing module, where k is an integer and satisfying: k≥0, l+k+1≤L.

To be specific, through deduction, the backward calculation difference of the output result of the (l+k)^{th} processing module may be determined through formula (6). To be specific, εₗ₊ₖ is obtained based on

$${ε}_{l + k + 1} \frac{\partial f ( {x}_{l + k} , {W}_{l + k} )}{\partial {x}_{l + k}} .$$

$$\frac{{dx}_{l + k}}{dt} = - {ε}_{l + k + 1} \frac{\partial f ( {x}_{l + k} , {W}_{l + k} )}{\partial {x}_{l + k}} ⇒ {ε}_{l + k} ← {ε}_{l + k + 1} \frac{\partial f ( {x}_{l + k} , {W}_{l + k} )}{\partial {x}_{l + k}} \qquad ( 6 )$$

After the backward calculation difference εₗ₊₁ of the output result of the l^{th} processing module is obtained based on formula (6), the expected output result

$${x}_{l + 1}^{*}$$

of the l^{th} processing module may be determined based on the backward calculation difference εₗ₊₁ of the output result of the l^{th} processing module and the output result x̅ₗ₊₁ of the l^{th} processing module. For example, in formula (7),

$${x}_{l + 1}^{*}$$

is obtained based on x̅ₗ₊₁ and εₗ₊₁, where x̅ₗ₊₁ represents the output of the l^{th} processing module in a case that the first local energy function converges.

$${x}_{l + 1}^{*} ← {\overline{x}}_{l + 1} - {ε}_{l + 1} \qquad ( 7 )$$

Updating the parameter of the l^{th} processing module based on the second local energy function may be implemented based on formula (8).

$$\frac{{dW}_{l}}{dt} = - \frac{\partial {E}_{local , l} {\vert}_{{λ}_{PC} = 1}}{\partial {W}_{l}} \qquad ( 8 )$$

where Wₗ represents the parameter of the l^{th} processing module. As can be seen, in formula (8), a gradient of the second local energy function Elocal with respect to the parameter Wₗ of the l^{th} processing module is calculated, and the gradient is then used to update the parameter of the l^{th} processing module.

Further, when the parameter of the l^{th} processing module is determined, the parameter of the l^{th} reference module may alternatively be updated based on the parameter of the l^{th} processing module.

For example, referring to formula (9), the parameter W̅ of a reference module may be updated by using an exponential moving average of the parameter of a processing module in at least one previous iteration.

$$\overline{W} ← τ \overline{W} + ( 1 - τ ) W \qquad ( 9 )$$

where 0≤τ≤1. As can be seen, the parameter W̅ of the reference module is associated with a historical result of the parameter of the processing module.

After the training on the information processing neural network model is completed according to the above processes, the information processing neural network model may be applied to extraction of an audio feature or prediction (or inpainting) of a missing part (or an unclear part) of an audio.

In some embodiments, according to the examples of FIG. 3A, FIG. 4B to FIG. 4C, and FIG. 5, the present disclosure further discloses a method for training a neural network model for audio processing. In some embodiments, the neural network model for audio processing is an example of the above information processing neural network model. The method includes: initializing the neural network model for audio processing and a reference neural network model corresponding to the neural network model for audio processing, the neural network model for audio processing including a plurality of processing modules, and the reference neural network model including a plurality of reference modules; updating a parameter of the neural network model for audio processing and a parameter of the reference neural network model through a plurality of iterations: in each iteration, determining audio features respectively corresponding to the plurality of reference modules based on an audio training sample and parameters of the plurality of reference modules; determining audio features respectively corresponding to the plurality of processing modules based on a masked sample obtained after performing mask processing on the audio training sample and parameters of the plurality of processing modules; updating the parameters of the plurality of processing modules based on the audio features respectively corresponding to the plurality of processing modules and the audio features respectively corresponding to the plurality of reference modules; and updating the parameters of the plurality of reference modules based on updated parameters of the plurality of processing modules. Then, in some embodiments, features of audio data may be extracted by using a trained neural network model for audio processing to further complete a speech recognition task, a sentiment analysis task, or the like. In addition, the neural network model for audio processing may be further used to restore the audio data.

It can be seen from the foregoing descriptions for FIG. 3A to FIG. 5 that in the neural network model training method of the present disclosure, each processing module in the information processing neural network model can be trained separately. Gradients of the loss function with respect to the parameters of other processing modules do not need to be clarified in this process. Therefore, difficulty of training the neural network model is lowered. Furthermore, the processing modules can be trained in parallel, thereby effectively improving efficiency of training the neural network model.

Since each processing module in the information processing neural network model can be independently trained, and the processing modules do not need to share their own network parameters, the neural network model training method of the present disclosure has good confidentiality, and can better protect the parameter of each processing module and prevent the parameter from being stolen. Therefore, the neural network model training method of the present disclosure has significant advantages to an application scenario (for example, related to trade secrets and personal privacy) having a high requirement for confidentiality.

The neural network model training method of the present disclosure can effectively reduce a calculation amount of a computer and save computer resources, and can fully use computer resources to implement parallel training on a plurality of processing modules, thereby reducing training time of the neural network model. The neural network model training method of the present disclosure can separately train each processing module, and has high training efficiency. Therefore, the method can be better applied to a training scenario for a large neural network model or a real-time training scenario for a neural network model (namely, training is performed while a task is processed, instead of a task processing process being completely independent from a training process).

In the neural network model training method of the present disclosure, the training on the processing modules may be performed by different servers. In the training process, the servers do not need to transmit their own network parameters, thereby effectively reducing an amount of data that needs to be transmitted between the servers, lowering a requirement on server performance, and lowering a requirement on a communication bandwidth during service.

Actually, in the present disclosure, the method for separately training each processing module in the information processing neural network model is closer to a process of processing information by a human brain (to be specific, each neuron processes information separately, and the information processing process relates only to inputs or outputs of neighboring neurons, instead of the sequential backhaul of information by a plurality of neurons). Therefore, an intelligent machine that can make a response in a manner similar to human intelligence.

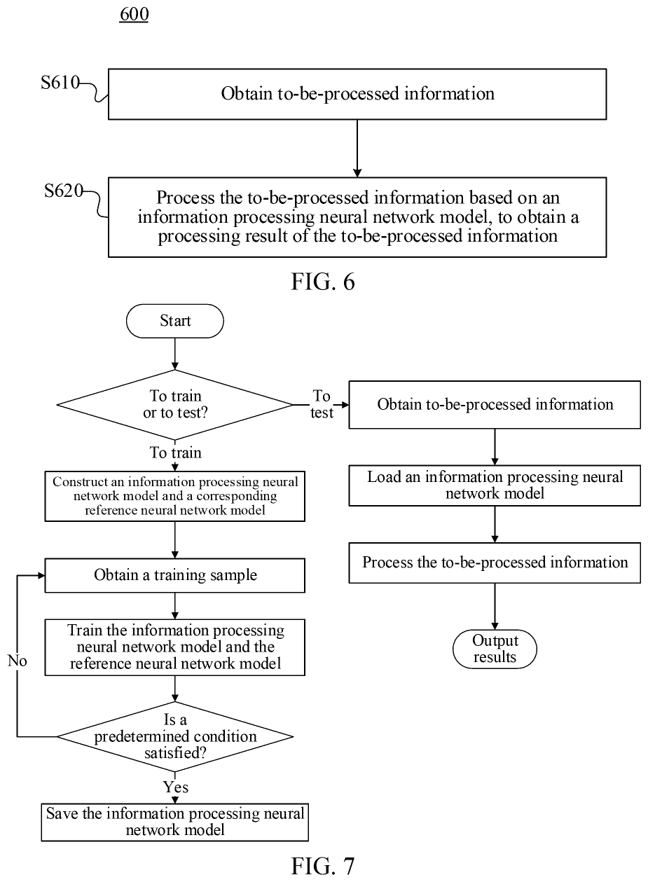

FIG. 6 is a schematic flowchart of an information processing method 600 based on a neural network model according to an embodiment of the present disclosure.

Operation S610: Obtain to-be-processed information.

The to-be-processed information may include one or more of image information, text information, audio information, and video information. To be specific, the method 600 may be configured for processing one type of data (for example, only text information is processed through machine translation), or may simultaneously process a plurality of types of data (for example, performing a pathological analysis based on both medical images and medical reports).

Operation S620: Process the to-be-processed information based on an information processing neural network model, to obtain a processing result of the to-be-processed information.

The information processing neural network model may be obtained by training through the method 300 as described in FIG. 3A to FIG. 3B. The information processing neural network model may be obtained by training based on only a training sample and a masked sample, to perform an information processing task such as feature extraction and missing information prediction. Or, based on this, for a downstream information processing task, the information processing neural network model may be obtained by further training based on a training sample of the downstream information processing task. The information processing neural network model that is further trained for the downstream information processing task may be configured for completing the downstream information processing task such as information extraction, information classification, information restoration, information style transfer, information augmentation, information mining, and information recognition.

After the processing result of the to-be-processed information is obtained based on operation S620, the processing result may be displayed on the terminal 120 shown in FIG. 1. In some embodiments, the server 110 or the terminal 120 shown in FIG. 1 may further analyze or display the processing result according to a need.

FIG. 7 is a schematic diagram of an information processing process based on a neural network model according to an embodiment of the present disclosure.

As shown in FIG. 7, the information processing process based on the neural network model according to this embodiment of the present disclosure includes a training stage of the neural network model and a testing stage of the neural network model (or a use stage of the neural network model).

In the training stage of the neural network model, an information processing neural network model may be first constructed. Then, a structure and parameter of a reference neural network model corresponding to the information processing neural network model may be determined based on a structure and parameter of the information processing neural network model. For example, assuming that the information processing neural network model includes L processing modules, a reference neural network model corresponding to the information processing neural network model may include L reference modules. An l^{th} processing module among the L processing modules and an l^{th} reference module among the L reference modules may have the same structures, where L and l are positive integers, and l≤L. In some embodiments, an initial parameter of the information processing neural network model and an initial parameter of the reference neural network model corresponding to the information processing neural network model may be initialized based on a random number.

In a training process, a training sample may be obtained, and the information processing neural network model and the reference neural network model may be trained based on the training sample. The training sample may include an image training sample, a text training sample, an audio training sample, a video training sample, or a combination thereof. The training process includes a plurality of iterations on a parameter of the information processing neural network model and a parameter of the reference neural network model.

Specifically, in each iteration, output results respectively corresponding to the plurality of reference modules may be determined based on the training sample and parameters of the plurality of reference modules. Output results respectively corresponding to the plurality of processing modules are determined based on a masked sample obtained after performing mask processing on the training sample and parameters of the plurality of processing modules. Then, the parameters of the plurality of processing modules may be updated based on the output results respectively corresponding to the plurality of processing modules and the output results respectively corresponding to the plurality of reference modules. Moreover, the parameters of the plurality of reference modules are updated based on updated parameters of the plurality of processing modules (for example, in each iteration process, the parameters of the plurality of reference modules may be updated by using values of the parameters of the plurality of processing modules in at least one previous iteration).

After each instance of iterative training is completed, whether a current training process satisfies a predetermined condition may be determined, and when the current training process satisfies the predetermined condition, the training on the information processing neural network model is determined to be completed, and the information processing neural network model is stored. If the current training process does not satisfy the predetermined condition, the training sample continues to be used to train the information processing neural network model and the reference neural network model corresponding to the information processing neural network model, and the parameter of the information processing neural network model and the parameter of the reference neural network model corresponding to the information processing neural network model are updated.

There may be a plurality of forms for the predetermined condition. For example, the predetermined condition may be that a preset number of instances of training are completed (For example, 1000, but not limited thereto. Each of the preset number of instances of training means training of an epoch, rather than training of a batch). Or, the predetermined condition may be that an energy function converges. The energy function is configured for evaluating accuracy of output results of the plurality of processing modules. Or, the predetermined condition may be that two conditions, namely, completion of a preset number of instances of training and convergence of an energy function, are simultaneously satisfied. Or, the predetermined condition may be that any one of two conditions, namely, completion of a preset number of instances of training and convergence of an energy function, is satisfied. In some embodiments, the energy function may be a global energy function for evaluating a difference between the output result of an L^{th} processing module and the output result of an L^{th} reference module, or may be a local energy function for evaluating a difference between the output result of the l^{th} processing module and the output result of a reference module corresponding to the l^{th} processing module, or may be determined jointly by the global energy function and the local energy function.

According to the preset number of instances of training, the training on the information processing neural network model is stopped after the preset number of instances of training are completed, so that network overfitting can be prevented, or long training time or a phenomenon of an inconspicuous network optimization effect can be prevented.

In the testing stage of the information processing neural network model, the to-be-processed information may be provided to a computer. The computer loads a trained information processing neural network model, processes the to-be-processed information through the trained information processing neural network model, and outputs a result for reference by a user. In some embodiments, the user may determine, based on the information processing result, whether the information processing neural network model needs to be further trained or optimized.

Similar to the training sample, the to-be-processed information may include information such as an image, text, an audio, or a video, or a combination thereof. The information processing neural network model may be configured for feature extraction, missing information prediction, information augmentation, information mining, and the like.

Similarly, an actual information processing process (namely, a process of using the information processing neural network model) is similar to the testing stage of the information processing neural network model, and details are not elaborated here.

Here, the training stage of the information processing neural network model and the testing stage (or the use stage) of the information processing neural network model, shown in FIG. 7, may be independently performed. To be specific, the information processing neural network model is trained first. After the training on the information processing neural network model is completed, the information processing neural network model is tested or used. In addition, the training stage of the information processing neural network model and the testing stage (or the use stage) of the information processing neural network model, shown in FIG. 7, may alternatively be alternately performed. For example, training may be performed while a task is processed, instead of a task processing process being completely independent from a training process. Therefore, the neural network model training method of the present disclosure can be better applied to a real-time training scenario for a neural network model.

Through testing and verification, the information processing neural network model training method of the present disclosure can separately train each processing module in the information processing neural network model, and the processing modules can be trained in parallel, thereby effectively improving efficiency of training the neural network model and shortening time of training the neural network model. Compared with an existing neural network model training method based on backward propagation, the neural network model training method of the present disclosure can effectively avoid a collapse problem in a neural network training process.

For example, as stated in related experiments, a data2vec2 model on which self-supervised training is performed based on backward propagation often has a collapse problem in the training process (for example, feature vectors obtained after all training samples are processed by a neural network are similar, and cannot reflect features of different training samples). Compared with the data2vec2 model, the method of the present disclosure does not have a collapse problem in a plurality of instances of tests and verifications. To be specific, the neural network model training method of the present disclosure has good stability.

For another example, the information processing neural network model may be preliminarily trained by using an LS-100from960h data set, and the information processing neural network model may be secondarily trained by using an LS-10from100h data set, so as to test performance of the neural network model training method of the present disclosure and performance of a method for performing self-supervised training based on backward propagation. Through testing and verification, compared with the method of performing the self-supervised training based on the backward propagation, the neural network model training method of the present disclosure dramatically improves a model training speed and accuracy of information processed by a model.

The neural network model training method of the present disclosure can improve accuracy and efficiency of sample feature extraction. When a downstream information processing task is performed based on a model trained by using the method, task processing accuracy and a task processing speed are both significantly improved.

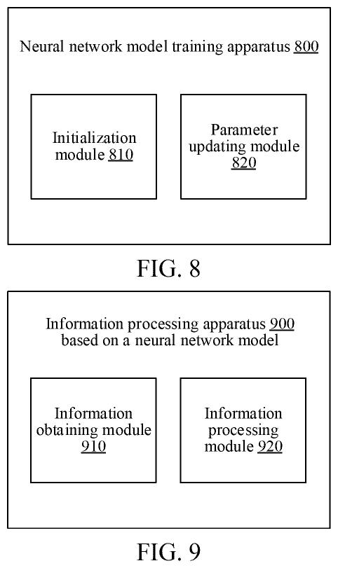

FIG. 8 is a schematic diagram of constitution of a neural network model training apparatus 800 according to an embodiment of the present disclosure.

According to this embodiment of the present disclosure, the neural network model training apparatus 800 may include: an initialization module 810 and a parameter updating module 820.

The initialization module 810 is configured to: initialize an information processing neural network model and a reference neural network model corresponding to the information processing neural network model, the information processing neural network model including a plurality of processing modules, and the reference neural network model including a plurality of reference modules.

According to this embodiment of the present disclosure, the plurality of processing modules may be L processing modules. The plurality of reference modules may be L reference modules. An l^{th} processing module among the L processing modules and an l^{th} reference module among the L reference modules have the same structures, where L and l are positive integers, and l≤L.

The parameter updating module 820 is configured to: update a parameter of the information processing neural network model and a parameter of the reference neural network model through a plurality of iterations.

According to this embodiment of the present disclosure, in each iteration, the parameter updating module 820 may determine output results respectively corresponding to the plurality of reference modules based on a training sample and parameters of the plurality of reference modules; determine output results respectively corresponding to the plurality of processing modules based on a masked sample obtained after performing mask processing on the training sample and parameters of the plurality of processing modules; update the parameters of the plurality of processing modules based on the output results respectively corresponding to the plurality of processing modules and the output results respectively corresponding to the plurality of reference modules; and then update the parameters of the plurality of reference modules based on updated parameters of the plurality of processing modules.

According to this embodiment of the present disclosure, for the l^{th} processing module among the L processing modules, the parameter of the l^{th} processing module may be updated based on the output result of the l^{th} processing module and the output result of a reference module corresponding to the l^{th} processing module. The reference module corresponding to the l^{th} processing module includes reference modules from an (l−m)^{th} reference module to an (l+n)^{th} reference module, and m and n are integers and satisfy m≥0, n≥0, l−m≥1, and l+n≤L.

According to this embodiment of the present disclosure, in the parameter updating process of the plurality of processing modules, a value of an energy function may be calculated based on the output results respectively corresponding to the plurality of processing modules and the output results respectively corresponding to the plurality of reference modules, and the parameters of the plurality of processing modules may be updated based on the value of the energy function. The energy function is configured for evaluating accuracy of the output results of the plurality of processing modules.

The neural network model training apparatus 800 may be configured for performing supervised training on the information processing neural network model or performing self-supervised training on the information processing neural network model.

The neural network model training apparatus 800 shown in FIG. 8 may implement the various neural network model training methods described with respect to FIG. 3A to FIG. 3B.

FIG. 9 is a schematic diagram of constitution of an information processing apparatus 900 based on a neural network model according to an embodiment of the present disclosure.

According to this embodiment of the present disclosure, the information processing apparatus 900 based on the neural network model may include: an information obtaining module 910 and an information processing module 920.

The information obtaining module 910 may be configured to: obtain to-be-processed information, the to-be-processed information including at least one of image information, text information, audio information, and video information.

The neural network model 920 for generating interaction information may be configured to: process the to-be-processed information based on an information processing neural network model, to obtain a processing result of the to-be-processed information.

The information processing apparatus 900 based on the neural network model shown in FIG. 9 may implement the various information processing methods based on a neural network model described with respect to FIG. 6. The information processing neural network model may be obtained by training through the method 300 as described in FIG. 3A to FIG. 3B.

The information processing apparatus 900 based on the neural network model may be located in the server 110 shown in FIG. 1 or the terminal 120 shown in FIG. 1.

Generally, the various exemplary embodiments the present disclosure can be implemented in hardware or dedicated circuits, software, firmware, logic, or any combination thereof. Some aspects can be implemented in hardware, while others can be implemented in firmware or software that can be executed by controllers, microprocessors, or other computing devices. When aspects of the embodiments of the present disclosure are illustrated or described as block diagrams, flowcharts, or some other graphical representations, the blocks, apparatuses, systems, techniques, or methods described herein can be implemented as non-limiting examples in hardware, software, firmware, a dedicated circuit or logic, general hardware, a controller, other computing devices, or some combinations thereof.

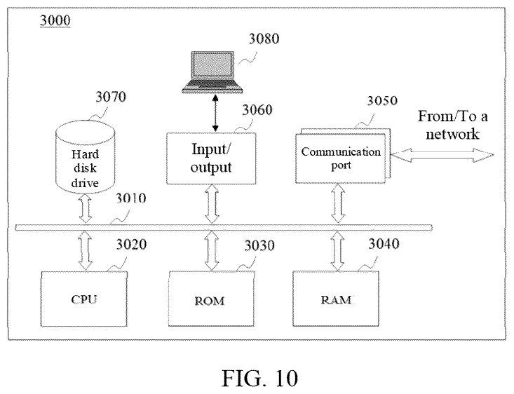

For example, the method or apparatus according to the embodiments of the present disclosure may alternatively be implemented by using an architecture of a computing device 3000 shown in FIG. 10. As shown in FIG. 10, the computing device 3000 may include a bus 3010, one or more central processing units (CPUs) 3020, a read-only memory (ROM) 3030, a random access memory (RAM) 3040, a communication port 3050 connected to a network, an input/output component 3060, a hard disk drive 3070, and the like. A storage device in the computing device 3000 such as the ROM 3030 or the hard disk drive 3070 may store various data or files for processing and/or communication in the method provided by the present disclosure and program instructions executed by the CPU. The computing device 3000 may further include a user interface 3080. Certainly, the architecture shown in FIG. 10 is merely an example. When implementing different devices, one or more components in the computing device shown in FIG. 10 may be omitted according to an actual need.

According to another aspect of the present disclosure, a computer-readable storage medium is further provided. The computer storage medium has a computer-readable instruction stored therein. The computer-readable instruction, when executed by a processor, may perform the method according to the embodiments of the present disclosure described with reference to the foregoing accompanying drawings. The computer-readable storage medium in the embodiments of the present disclosure may be a volatile memory or a non-volatile memory, or may include both a volatile memory and a non-volatile memory. The non-volatile memory may include a read-only memory (ROM), a programmable read-only memory (PROM), an erasable programmable read-only memory (EPROM), an electrically erasable programmable read-only memory (EEPROM) or a flash memory. The volatile memory may include a RAM, which is used as an external cache. Through illustrative but not limited description, RAMs in many forms, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM), are available. The memory in the method described herein includes but is not limited to these memories and any other suitable types. The memory in the method described herein includes but is not limited to these memories and any other suitable types.

An embodiment of the present disclosure further provides a computer program product or a computer program. The computer program product or the computer program includes a computer instruction which is stored in a computer-readable storage medium. A processor of a computer device reads the computer instruction from the computer-readable storage medium and executes the computer instruction, causing the computer device to perform the method according to the embodiments of the present disclosure.

In conclusion, the embodiments of the present disclosure disclose a neural network model training method and apparatus, a computer program product, and a storage medium. The method includes: initializing an information processing neural network model and a reference neural network model corresponding to the information processing neural network model, the information processing neural network model including a plurality of processing modules, and the reference neural network model including a plurality of reference modules; and updating a parameter of the information processing neural network model and a parameter of the reference neural network model through a plurality of iterations: in each iteration, determining output results respectively corresponding to the plurality of reference modules based on a training sample and parameters of the plurality of reference modules; determining output results respectively corresponding to the plurality of processing modules based on a masked sample obtained after performing mask processing on the training sample and parameters of the plurality of processing modules; updating the parameters of the plurality of processing modules based on the output results respectively corresponding to the plurality of processing modules and the output results respectively corresponding to the plurality of reference modules; and updating the parameters of the plurality of reference modules based on updated parameters of the plurality of processing modules.

According to the neural network model training method of the present disclosure, each processing module in the information processing neural network model can be trained separately, and the processing modules can be trained in parallel, thereby effectively improving efficiency of training the neural network model. In the neural network model training method of the present disclosure, a processing module can be trained based only on an output result of the processing module and an output result of a reference module corresponding to the processing module. Gradients of a loss function with respect to parameters of other processing modules do not need to be clarified in this process. Therefore, difficulty of training the neural network model is lowered; computer resources can be effectively saved; and a requirement on computer performance can be reduced.

In addition, since each processing module in the information processing neural network model can be independently trained, and the processing modules do not need to share their own network parameters, the neural network model training method of the present disclosure has good confidentiality, and can better protect the parameter of each processing module and prevent the parameter from being stolen. Therefore, the neural network model training method of the present disclosure has significant advantages to an application scenario having a high requirement for confidentiality.

The neural network model training method of the present disclosure can effectively reduce a calculation amount of a computer and fully use computer resources to implement parallel training on a plurality of processing modules, thereby reducing training time of the neural network model. The neural network model training method of the present disclosure can separately train each processing module, and has high training efficiency. Therefore, the method can be better applied to a training scenario for a large neural network model or a real-time training scenario for a neural network model.

In the neural network model training method of the present disclosure, the training on the processing modules may be performed by different servers. In the training process, the servers do not need to transmit their own network parameters, thereby effectively reducing an amount of data that needs to be transmitted between the servers, lowering a requirement on server performance, and lowering a requirement on a communication bandwidth during service.

In addition, compared with an existing neural network model training method based on backward propagation, the neural network model training method of the present disclosure can stably train a neural network model and effectively avoid a collapse problem in a neural network training process.

Actually, in the present disclosure, the method for separately training each processing module in the information processing neural network model is closer to a process of processing information by a human brain (to be specific, each neuron processes information separately, and the information processing process relates only to inputs or outputs of neighboring neurons, instead of the sequential backhaul of information by a plurality of neurons). Therefore, an intelligent machine that can make a response in a manner similar to human intelligence.

Through testing and verification, compared with the method of performing the self-supervised training based on the backward propagation, the neural network model training method of the present disclosure dramatically improves a model training speed and accuracy of information processed by a model.

Here, flowcharts and block diagrams in the accompanying drawings illustrate possible system architectures, functions and operations that may be implemented by systems, methods, and computer program products according to the embodiments of the present disclosure. In this regard, each block in a flowchart or a block diagram may represent a module, a program, or a part of a code. The module, the program, or the part of the code includes at least one executable instruction used for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The present disclosure uses specific terms to describe embodiments of the present disclosure. For example, “first/second embodiment”, “an embodiment”, and/or “some embodiments” refer to a particular feature, structure, or characteristic related to at least one embodiment of the present disclosure. Therefore, it is emphasized that two or more references to “an embodiment” or “one embodiment” or “an alternative embodiment” at different positions in this specification do not necessarily refer to the same embodiment. In addition, certain features, structures, or characteristics in one or more embodiments of the present disclosure may be appropriately combined.

Unless otherwise defined, all terms (including technical and scientific terms) used herein have the same meaning as commonly understood by a person of ordinary skill in the art to which the present disclosure belongs. The terms such as those defined in commonly used dictionaries are to be interpreted as having meanings that are consistent with the meanings in the context of the related art, and are not to be interpreted in an idealized or extremely formalized sense, unless expressively so defined herein.

The above is a description of the present disclosure, and is not to be considered as a limitation on the present disclosure. Although several exemplary embodiments of the present disclosure are described, a person skilled in the art may easily understand that many changes can be made to the exemplary embodiments without departing from novel teaching and advantages of the present disclosure. Therefore, the changes are intended to be included within the scope of the present disclosure as defined by the claims. The above is a description of the present disclosure, and is not to be considered to be limited by the disclosed specific embodiments, and modifications to the disclosed embodiments and other embodiments fall within the scope of the appended claims. The present disclosure is subject to the claims and equivalents thereof.

What is claimed is:

1. A neural network model training method, comprising:
initializing an information processing neural network model and a reference neural network model corresponding to the information processing neural network model, the information processing neural network model comprising a plurality of processing modules, and the reference neural network model comprising a plurality of reference modules; and
updating a parameter of the information processing neural network model and a parameter of the reference neural network model through a plurality of iterations, wherein each iteration comprises:
obtaining output results respectively corresponding to the plurality of reference modules based on a training sample and parameters of the plurality of reference modules by inputting the training sample to the plurality of reference modules for forward calculation and respectively outputting corresponding calculation results;
obtaining, based on a masked sample obtained after performing mask processing on the training sample and parameters of the plurality of processing modules, output results respectively corresponding to the plurality of processing modules by inputting the masked sample to the plurality of processing modules for forward calculation and respectively outputting corresponding calculation results;
updating the parameters of the plurality of processing modules based on the output results respectively corresponding to the plurality of processing modules and the output results respectively corresponding to the plurality of reference modules; and
updating the parameters of the plurality of reference modules based on updated parameters of the plurality of processing modules.

2. The method according to claim 1, wherein the updating the parameters of the plurality of reference modules based on updated parameters of the plurality of processing comprises:
updating the parameters of the plurality of reference modules by using values of the parameters of the plurality of processing modules in at least one previous iteration.

3. The method according to claim 2, wherein the updating the parameters of the plurality of reference modules by using values of the parameters of the plurality of processing modules in at least one previous iteration comprises:
updating the parameters of the plurality of reference modules by using an exponential moving average of the parameters of the plurality of processing modules in the at least one previous iteration.

4. The method according to claim 1, wherein the plurality of processing modules are L processing modules; the plurality of reference modules are L reference modules; and an l^{th} processing module among the L processing modules and an l^{th} reference module among the L reference modules have the same structures, wherein L and l are positive integers, and l≤L.

5. The method according to claim 4, wherein the updating the parameters of the plurality of processing modules based on the output results respectively corresponding to the plurality of processing modules and the output results respectively corresponding to the plurality of reference modules comprises:
for the l^{th} processing module among the L processing modules,
updating the parameter of the l^{th} processing module based on the output result of the l^{th} processing module and the output result of a reference module corresponding to the l^{th} processing module, the reference module corresponding to the l^{th} processing module comprising reference modules from an (l−m)^{th} reference module to an (l+n)^{th} reference module, and m and n being integers and satisfying m≥0, n≥0, l−m≥1, and l+n≤L.

6. The method according to claim 4, wherein the updating the parameters of the plurality of processing modules based on the output results respectively corresponding to the plurality of processing modules and the output results respectively corresponding to the plurality of reference modules comprises:
calculating a value of an energy function based on the output results respectively corresponding to the plurality of processing modules and the output results respectively corresponding to the plurality of reference modules, and updating the parameters of the plurality of processing modules based on the value of the energy function, the energy function being configured for evaluating accuracy of the output results of the plurality of processing modules.

7. The method according to claim 6, wherein the energy function comprises a global energy function and a local energy function;
the global energy function is configured for evaluating a difference between the output result of an L^{th} processing module and the output result of an L^{th} reference module; and the local energy function is configured for evaluating a difference between the output result of the l^{th} processing module and the output result of the reference module corresponding to the l^{th} processing module.

8. The method according to claim 7, wherein the local energy function comprises: a first local energy function and a second local energy function; and
the calculating a value of an energy function based on the output results respectively corresponding to the plurality of processing modules and the output results respectively corresponding to the plurality of reference modules comprises:
for the l^{th} processing module among the L processing modules,
determining a value of the first local energy function based on the difference between the output result of the l^{th} processing module and the output result of the reference module corresponding to the l^{th} processing module;
determining an expected output result of the l^{th} processing module based on the global energy function; and
determining a value of the second local energy function based on a difference between the output result of the l^{th} processing module and the expected output result of the l^{th} processing module.

9. The method according to claim 8, wherein the determining an expected output result of the l^{th} processing module based on the global energy function comprises:
determining a backward calculation difference of the output result of the l^{th} processing module based on a value of the global energy function; and
determining the expected output result of the l^{th} processing module based on the backward calculation difference of the output result of the l^{th} processing module and the output result of the l^{th} processing module.

10. The method according to claim 9, wherein the determining a backward calculation difference of the output result of the l^{th} processing module based on a value of the global energy function comprises:
for an (l+k)^{th} processing module among the processing modules from the L^{h} processing module to the l^{th} processing module,
calculating a partial derivative of the output result of the (l+k)^{th} processing module with respect to an output result of an (l+k−1)^{th} processing module, the output result of the (l+k−1)^{th} processing module being an input of the (l+k)^{th} processing module; and
determining a backward calculation difference of the output result of the (l+k)^{th} processing module based on the partial derivative and a backward calculation difference of an output result of an (l+k+1)^{th} processing module, k being an integer and satisfying: k≥0, l+k+1≤L.

11. The method according to claim 8, wherein the updating the parameters of the plurality of processing modules comprises:
performing weighting calculation on the first local energy function and the second local energy function that correspond to the l^{th} processing module, to obtain a third local energy function, and
updating the parameter of the l^{th} processing module based on the third local energy function.

12. The method according to claim 8, wherein the updating the parameters of the plurality of processing modules comprises:
updating the parameter of the l^{th} processing module based on the value of the first local energy function corresponding to the l^{th} processing module when the first local energy function corresponding to the l^{th} processing module does not converge; and
updating the parameter of the l^{th} processing module based on the second local energy function corresponding to the l^{th} processing module when the first local energy function corresponding to the l^{th} processing module converges.

13. The method according to claim 1, wherein each of the plurality of processing modules or each of the plurality of reference modules is a sub-neural network model or a neural network layer; and
each processing module or each reference module comprises: one or more of a convolutional neural network, an attention-mechanism-based neural network, a recurrent neural network, a recursive neural network, a feedforward neural network, a generative adversarial neural network, and a deep neural network.

14. The method according to claim 1,
the method being configured for performing supervised training on the information processing neural network model or performing self-supervised training on the information processing neural network model.

15. The method according to claim 1, wherein
the performing mask processing on the training sample comprises: performing at least one of mask processing with different sizes, mask processing with different positions, or mask processing with different shapes on the training sample; and
the training sample comprises at least one of an image training sample, a text training sample, an audio training sample, and a video training sample.

16. The method according to claim 1, further comprising:
completing the training on the information processing neural network model when the updated information processing neural network model satisfies a predetermined condition, and obtaining a trained information processing neural network model; and
further training the trained information processing neural network model by using an information processing training sample corresponding to an information processing task, the information processing task comprising at least one of information extraction, information classification, information restoration, information style transfer, information augmentation, information mining, and information recognition.

17. An information processing method based on a neural network model, comprising;
obtaining to-be-processed information, the to-be-processed information comprising at least one of image information, text information, audio information, and video information; and
processing the to-be-processed information based on an information processing neural network model, to obtain a processing result of the to-be-processed information, the information processing neural network model being obtained by training through:
initializing an information processing neural network model and a reference neural network model corresponding to the information processing neural network model, the information processing neural network model comprising a plurality of processing modules, and the reference neural network model comprising a plurality of reference modules; and
updating a parameter of the information processing neural network model and a parameter of the reference neural network model through a plurality of iterations, wherein each iteration comprises:
obtaining output results respectively corresponding to the plurality of reference modules based on a training sample and parameters of the plurality of reference modules by inputting the training sample to the plurality of reference modules for forward calculation and respectively outputting corresponding calculation results;
obtaining, based on a masked sample obtained after performing mask processing on the training sample and parameters of the plurality of processing modules, output results respectively corresponding to the plurality of processing modules by inputting the masked sample to the plurality of processing modules for forward calculation and respectively outputting corresponding calculation results;
updating the parameters of the plurality of processing modules based on the output results respectively corresponding to the plurality of processing modules and the output results respectively corresponding to the plurality of reference modules; and
updating the parameters of the plurality of reference modules based on updated parameters of the plurality of processing modules.

18. An electronic device comprising:
a memory storing a plurality of instructions; and
a processor configured to execute the plurality of instructions, wherein upon execution of the plurality of instructions, the processor is configured to:
initialize an information processing neural network model and a reference neural network model corresponding to the information processing neural network model, the information processing neural network model comprising a plurality of processing modules, and the reference neural network model comprising a plurality of reference modules; and
update a parameter of the information processing neural network model and a parameter of the reference neural network model through a plurality of iterations, wherein in each iteration, the processor is configured to:
obtain output results respectively corresponding to the plurality of reference modules based on a training sample and parameters of the plurality of reference modules by inputting the training sample to the plurality of reference modules for forward calculation and respectively outputting corresponding calculation results;
obtain, based on a masked sample obtained after performing mask processing on the training sample and parameters of the plurality of processing modules, output results respectively corresponding to the plurality of processing modules by inputting the masked sample to the plurality of processing modules for forward calculation and respectively outputting corresponding calculation results;
update the parameters of the plurality of processing modules based on the output results respectively corresponding to the plurality of processing modules and the output results respectively corresponding to the plurality of reference modules; and
update the parameters of the plurality of reference modules based on updated parameters of the plurality of processing modules.

19. The electronic device according to claim 18, wherein in order to update the parameters of the plurality of reference modules based on updated parameters of the plurality of processing, the processor, upon execution of the plurality of instructions, is configured to:
update the parameters of the plurality of reference modules by using values of the parameters of the plurality of processing modules in at least one previous iteration.

20. The electronic device according to claim 18, wherein the plurality of processing modules are L processing modules; the plurality of reference modules are L reference modules; and an l^{th} processing module among the L processing modules and an l^{th} reference module among the L reference modules have the same structures, wherein L and l are positive integers, and l≤L.
